(19) United States
(12) Patent Application Publication
(10) Pub. No.: US 2020/0258400 A1
(43) Pub. Date: Aug. 13, 2020

(54) GROUND-AWARE UAV FLIGHT PLANNING AND OPERATION SYSTEM

(71) Applicant: Foresight AI Inc., Los Gatos, CA (US)

(72) Inventors: Chang Yuan, Los Gatos, CA (US); Ken Christensen, Santa Clara, CA (US)

(21) Appl. No.: 16/567,067

(22) Filed: Sep. 11, 2019

Related U.S. Application Data
(60) Provisional application No. 62/805,185, filed on Feb. 13, 2019.

(51) Int. Cl. G08G 5/00; B64C 39/02; G06K 9/00; G05D 1/06

(52) U.S. Cl. CPC G08G 5/0039; B64C 39/024; G06K 9/00651; B64C 2201/18; G05D 1/0676; B64C 2201/145; G06K 9/00718

(57) ABSTRACT

A ground-aware drone flight planning and operation system is provided. The system may comprise a semantic map, a localization system, and a perception system. The semantic map may comprise information about ground events in a geographic area where an unmanned aerial vehicle (UAV) may operate. The localization system may localize the UAV and assist in determining nearby ground events using the semantic map. The perception system may determine real-time ground events in the vicinity of the UAV. A computerized flight planner may generate a flight path based on the localization and perception data.

### CROSS-REFERENCE TO RELATED APPLICATION

This application claims the benefit of U.S. Provisional Application No. 62/805,185, filed on Feb. 13, 2019, which is hereby incorporated by reference in its entirety.

### BACKGROUND

Unmanned aerial vehicles (UAVs) are capable of traveling through the air without a physically-present human operator. UAVs may operate in an autonomous mode, remote-control mode, or partially autonomous mode

In a fully autonomous mode, the UAV may automatically determine its own path and operate one or more propulsion components and control components to navigate along the path. In a remote-control mode, a human operator that is remote from the UAV controls the UAV to travel along a flight path. The flight may be developed by a human or by a computer. In a partially autonomous mode, some aspects of the UAVs flight may be performed autonomously by the UAV and other aspects of the flight may be performed under remote control.

UAVs may be used for a variety of tasks. However, to date the flight paths created for UAVs have been based on coordinate systems and not based on ground-awareness. That is, the UAVs are not aware of the situation below them on the ground. This has several disadvantages. First, it can create a dangerous situation if the UAV flies over or near objects on the ground such as people or vehicles that could be injured or damaged by a falling UAV. Second, it can lead to violation of regulations implemented by the government, such as the Federal Aviation Administration and other bodies, that require UAVs to follow certain rules. Third, it can lead to non-optimal routes for the UAV if the UAV flies near ground objects that it will have to go out of its way to avoid. Other disadvantages of a non-ground-aware UAV will also become apparent from this disclosure.

### SUMMARY

In some implementations, a method for generating and updating a flight path is performed based on ground-awareness.

In some embodiments, data from a semantic map, localization system, and perception system are used to generate or update a flight path based on awareness of ground objects or conditions.

In some embodiments, a UAV is provided and comprises a plurality of sensors. Localization may be performed by the localization system by applying the sensor data of the UAV. Localization may also be performed by using a semantic map to place the UAV in a coordinate system of other semantic information. Perception may be performed by the perception system by applying the sensor data of the UAV. As a result of localization and perception, ground objects and conditions are identified. A flight path is generated or updated based on the ground objects and conditions.

In some embodiments, the UAV stores an emergency landing location. The emergency landing location may also be selected based on the locations of ground objects and conditions identified through localization and perception.

### BRIEF DESCRIPTION OF THE DRAWINGS

The present disclosure will become better understood from the detailed description and the drawings, a brief summary of which is provided below.

FIG. 1 illustrates an exemplary environment in which systems herein may operate.

FIG. 2 illustrates an exemplary embodiment of a UAV.

FIG. 3 illustrates an exemplary embodiment of a computer system that may be used in some embodiments.

FIG. 4 illustrates an exemplary method for updating a flight path based on ground-awareness.

FIG. 5 illustrates an exemplary method that may be performed in some embodiments to generate an initial flight path and update the flight path during flight.

FIG. 6 illustrates an exemplary method for using a cost function and flight planner to generate a flight path.

FIG. 7 illustrates an exemplary flight path comprising a plurality of waypoints.

FIG. 8 illustrates an exemplary flight path that may be used for minimizing turns and optimizing for straight line travel.

FIG. 9 illustrates an exemplary flight path that may be used for surveying and mapping roads.

FIG. 10 illustrates an exemplary flight path that may be used for traffic monitoring.

FIG. 11 illustrates an exemplary flight path that may be used for goods delivery by the UAV

### DETAILED DESCRIPTION

For simplicity and illustrative purposes, the principles of the present teachings are described by referring mainly to examples of various implementations thereof. However, one of ordinary skill in the art would readily recognize that the same principles are equally applicable to, and can be implemented in, all types of information and systems, and that any such variations do not depart from the true spirit and scope of the present teachings. Moreover, in the following detailed description, references are made to the accompanying figures, which illustrate specific examples of various implementations. Logical and structural changes can be made to the examples of the various implementations without departing from the spirit and scope of the present teachings. The following detailed description is, therefore, not to be taken in a limiting sense and the scope of the present teachings is defined by the appended claims and their equivalents.

In addition, it should be understood that steps of the examples of the methods set forth in the present disclosure can be performed in different orders than the order presented in the present disclosure. Furthermore, some steps of the examples of the methods can be performed in parallel rather than being performed sequentially. Also, the steps of the examples of the methods can be performed in a network environment in which some steps are performed by different computers in the networked environment.

Some implementations are implemented by a computer system. A computer system can include a processor, a memory, and a non-transitory computer-readable medium. The memory and non-transitory medium can store instructions for performing methods and steps described herein.

Embodiments herein relate to automatically creating flight paths for UAVs, and in particular, to automatically create flight paths based on ground-awareness. Ground-awareness relates to being aware of objects and conditions on the ground underneath or in the vicinity of the UAV. For example, a ground-aware UAV may identify a location of a road on the ground and maintain a buffer distance between the UAV and the road to comply with regulations about how close a UAV may fly within a road and also to maintain safety for the vehicles on the road. For example, if the UAV encounters problems and falls to the ground, it would not interfere with the vehicles on the road. In another example, a computerized flight planner may develop a flight path that prefers to travel over less populous areas instead of more populous areas. This can reduce the risk that a falling UAV will injure someone or damage property and also reduce the incidence of noise disruptions.

A ground-aware flight plan may be generated through the combination of a semantic map, localization system, and perception system. The semantic map provides a detailed map of the environment including semantic information in the map about objects and conditions on the ground. The localization system precisely localizes the UAV in the environment and may use any one or combination of global navigation satellite system (GNSS), global positioning system (GPS), inertial measurement unit (IMU), perception-based localization systems (e.g., image-based, LIDAR based, depth-sensor based, and so on), and sensor fusion of the aforementioned approaches. After the precise localization of the UAV, the UAV is aware of the ground objects and conditions in its vicinity and relation to the UAV based on the detailed semantic map.

The perception system allows the UAV to perceive the environment in real-time using one or more sensors and a computer system for interpreting the sensor inputs. The perception system may include one or more of a camera, video camera, light detection and ranging (LIDAR), depth sensor, ultra-sonic sensor, radar, and other sensors. The sensor data collected by the perception system may be used for localization as described herein. In addition, the sensor data of the perception system may allow the UAV to detect real-time conditions in the environment that would not be known from the semantic map. For example, the perception system may be used to detect recent changes to the environment, such as new buildings, roads, or street signs, or be used to detect the real-time presence of vehicles, people, and other moving objects. The perception system may also be used to detect whether vehicles and other objects are currently moving or stationary, and thus whether it is allowed to fly over them (when stationary) or not (when moving).

A computerized flight planner may use the information from the semantic map, localization system, and perception system to generate a flight path. The UAV may then navigate along the flight path. During the flight, new detections by the perception system may cause the UAV to detect the existence of ground conditions that may cause the flight path to be re-evaluated. The ground conditions may be input to the computerized flight planner to determine an updated flight path. In some embodiments, the updated flight path may comprise delaying the UAV, for example to wait for vehicles to stop at an intersection so that the UAV may safely pass over them. In some embodiments, the updated flight path may comprise changing the coordinates of the flight path, such as if an unexpected obstacle is detected.

In some embodiments, the computerized flight planner may apply a cost function to one or more ground objects or conditions, where the ground objects or conditions may be detected from the semantic map as a result of localization or from the perception system. The cost function may accept as input an identity of the ground object or event and output weights associated with the travel of the UAV over or in the vicinity of the ground object or event. The weights may be associated with the cost of the UAV to fly along a path that would cross over or in the vicinity of the ground object or event. In other embodiments, the cost function may accept as input the raw sensor readings or semantic map data and output the weights associated with the travel of the UAV along a path over or in the vicinity of a region. Although referred to in the singular as a cost function, it should be understood that a plurality of cost functions may be used, such as for different types of ground objects and conditions. The computerized flight planner may use the weights to compute a lowest cost flight path using pathfinding algorithms such as rapidly exploring random tree algorithm (RRT), A* algorithm, Dijkstra's algorithm, D* algorithm, any-angle path finding, hierarchical path finding, and other algorithms.

In some embodiments, the ground objects or conditions detected from the semantic map or perceptions system may be impassable by the UAV, such as a tall tree or a region that cannot be passed due to government regulations. The impassable ground objects or conditions may be represented as an impassable barrier in the computerized flight planner. It may generate a path using the pathfinding algorithm by using a combination of weights generated by the cost function and the impassable obstacles. The pathfinding algorithm may generate paths based on both the path weights and the obstacles, and a lowest cost flight path may be select.

In some embodiments, the flight paths generated by the computerized flight planner are represented by a plurality of waypoints. The waypoints may represent intermediate steps on the flight path. In some embodiments, the flight path comprises flying in a straight line or substantially straight line between waypoints, so that any turns are represented by adding a new waypoint to the flight path. The UAV may deviate from the straight line path between waypoints when an obstacle or ground object or condition would require it or render a new path more efficient.

The terms “unmanned aerial vehicle” and “UAV” may refer to an aerial vehicle without a physically-present human operator. The terms “drone,” “unmanned aerial vehicle system” (UAVS), or “unmanned aerial system” (UAS) may also be used to refer to a UAV.

UAVs may operate autonomously, partially autonomously, or by remote control of a human operator. An autonomous UAV may automatically develop a flight path and navigate along the flight path through a computer processor that operates one or more propulsion components and control components. In some embodiments, the autonomous UAV may require a manually developed flight path but may navigate automatically along the flight path without human control or intervention. In some embodiments, an autonomous UAV is supervised by a human operator, who can take over control if necessary, even though control is by default performed by a computer processor. A remote-control UAV may be under the control of a human operator who is remote from the UAV. The human operator may control the UAV through a control interface. Control commands may be received from the human operator at the control interface and transmitted, through wireless or wired communication, to the UAV. One or more propulsion components and control components may be controlled through operation of the human-operated control interface. Moreover, the UAV may record video, photo, and sensor data to transmit back to the human operator to allow the human operator to perceive the vicinity of the UAV. A partially autonomous UAV may include both autonomous and remote-control aspects. In one embodiment, the autonomous and remote-control commands may occur at different levels of abstraction. For example, a human operator may input commands for the UAV to travel from a start location to an end location, and an autonomous piloting system may automatically perform the low-level navigation tasks for controlling the propulsion and control systems of the UAV to fly the UAV from the start location to the end location. In such an embodiment, the human may provide high-level control and the UAV may autonomously perform low-level control. Vice versa, an autonomous UAV may perform high-level control in the form of autonomously developing a flight path and handing off the low-level control to the human-operator to perform the individual real-time control necessary to guide the UAV along the flight path. In other embodiments of a partially autonomous UAV, the split of control between the autonomous and remote-control aspect may be at the same level of abstraction. For example, the UAV may be flown in an autonomous mode until an obstacle or other difficult to navigate situation is encountered, when control is switched to remote-control by a human operator.

While embodiments herein are illustrated with reference to UAVs, the techniques herein may also be applied to ground vehicles. For example, techniques herein may be used for path planning, navigation, and operation of unmanned ground vehicles (UGVs).

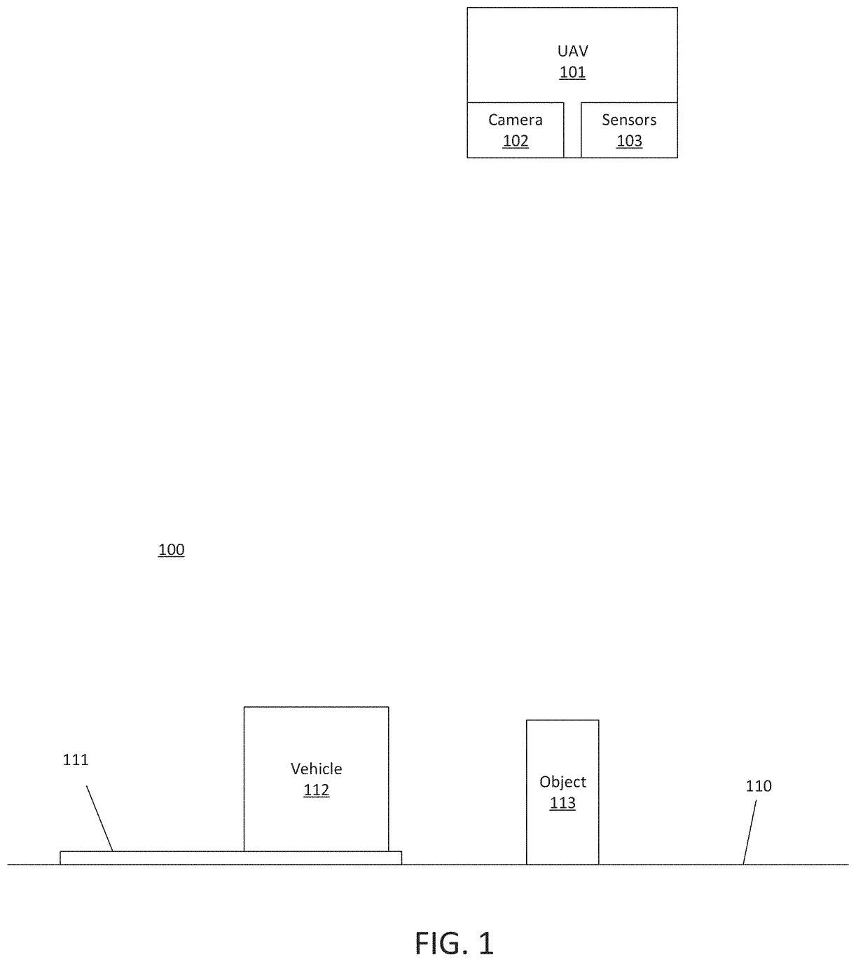

FIG. 1 illustrates an exemplary environment 100 in which systems herein may operate. A UAV 101 may fly in the air above the ground 110. The UAV may include a camera 102 and sensors 103 directed at the ground to collect photos, videos, and other sensor data indicating objects and conditions on the ground. The term “ground events” refers to either objects or conditions on the ground. Ground conditions may be either temporary, permanent, or semi-permanent and may refer to not just objects but also situations, such as whether vehicles are moving or stationary or whether there is traffic on a road. The term ground events refers to any sort of object, condition, or data about an occurrence on the ground. Through the use of camera 102 and sensors 103 the UAV gains awareness of ground events.

The UAV may travel over any sort of terrain, such as populated or unpopulated, urban or rural, and so on. Objects on the ground may include a road 111 and vehicle 112. Other objects 113 may also be on the ground in the vicinity of the UAV, such as people, trees, vegetation, buildings, structures, road signs, pathways, animals, sidewalks, lawns, hills, mountains, natural formations, water, streams, canals, rivers, oceans, and so on.

A UAV may be of various forms. For example, a UAV may be a rotorcraft such as a helicopter or multicopter, a fixed-wing aircraft, a jet aircraft, a ducted fan aircraft, a lighter-than-air dirigible such as a blimp or steerable balloon, a tail-sitter aircraft, a glider aircraft, an ornithopter, and so on.

In one embodiment, a UAV is a rotorcraft. A rotorcraft includes helicopters, which typically include two rotors, and multicopters, which have more than two rotors. In a rotorcraft, the rotors provide propulsion and control for the vehicle. Each rotor includes blades attached to a motor, and the rotors may allow the rotorcraft to take off and land vertically, to maneuver in any direction, and to hover. The pitch of the blades may be adjusted as a group or differentially to allow the rotorcraft to perform aerial maneuvers. Additionally, the rotorcraft may propel and maneuver itself by adjusting the rotation rate of the motors, collectively or differentially.

In one embodiment, a UAV is a tail-sitter UAV. A tail-sitter UAV may comprise fixed wings for providing lift and allowing the UAV to glide horizontally. However, during launch the tail-sitter UAV may be positioned vertically with fins and wings resting on the ground and stabilizing the UAV in a vertical position. The tail-sitter UAV may take off by operating propellers to generate upward thrust. In the air, the tail-sitter UAV may use one or more flaps to turn itself into a horizontal position. The propellers may provide forward thrust so that the tail-sitter UAV may fly in a similar manner as a typical airplane.

In one embodiment, the UAV is a fixed-wing aircraft, which may also be referred to as an airplane, aeroplane, or a plane. A fixed-wing aircraft may comprise a fuselage and stationary wings that generate lift based on the wing shape and the vehicle's forward airspeed. In a common configuration, a fixed-wing UAV includes two horizontal wings, a vertical stabilizer (also referred to as a fin) to stabilize the plane's yaw, a horizontal stabilizer (also referred to as an elevator or tailplane) to stabilize pitch (tilt up or down), and a propulsion unit. The propulsion unit may include, for example, a motor, shaft, and propeller, or a jet engine.

The aforementioned embodiments are exemplary only and the UAV may take any number of other forms.

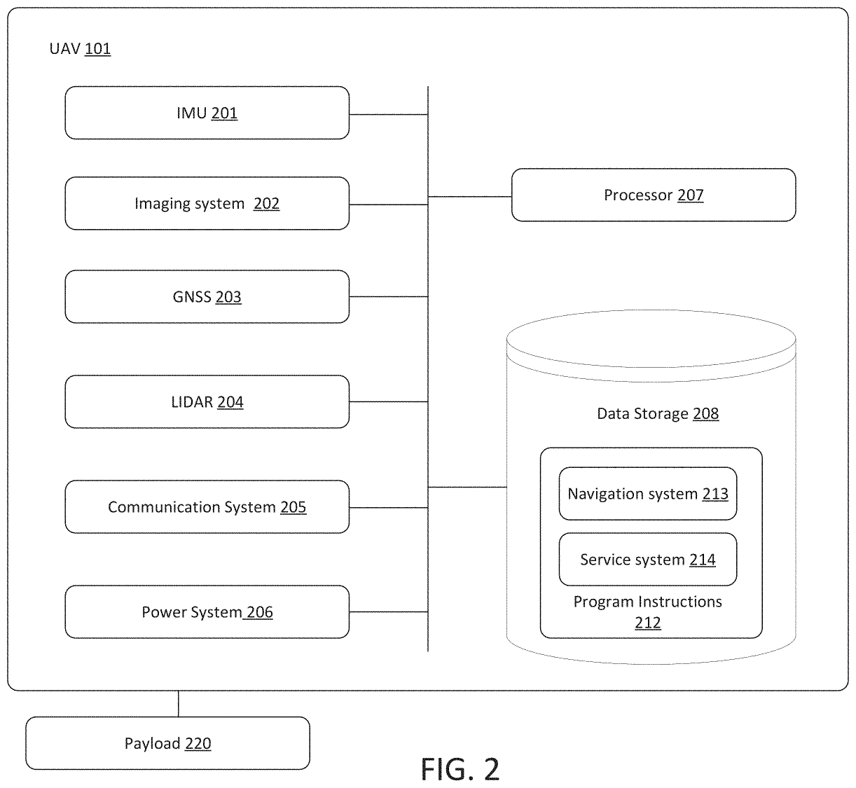

FIG. 2 illustrates an exemplary embodiment of a UAV 101. UAV 101 may comprise a processor 207 and data storage 208, including one or more program instructions 212, in addition to sensor systems, a communication system 205, and power system 206.

IMU 201 comprise components for determining the orientation, position, and movement of the UAV. The IMU 201 may comprise an accelerometer and gyroscope, where the accelerometer may measure the orientation of the vehicle with respect to the earth and the gyroscope measures the rate of rotation around an axis. The IMU 201 may optionally include other sensors such as magnetometers and pressure sensors. A magnetometer may measure direction by using an electronic compass to determine heading information. A pressure sensor may be used to determine the altitude of the UAV.

Imaging system 202 may comprise components for imaging the environment in the vicinity of the UAV. In an embodiment, the imaging system 202 comprises a red, green, and blue (RGB) camera. An RGB camera may capture photographic and video imagery in the visible spectrum of RGB light. Imaging system 202 may optionally include other imaging components such as an infra-red camera for capturing light in the infra-red spectrum or a depth sensor for capturing depth information in an image. The imaging system 202 may comprise a still camera, a video camera, or both. The imaging system 202 may be used for object detection, localization, mapping, and other applications.

GNSS receiver 203 may communicate with satellites to provide coordinates of the UAV. In one example, the GNSS receiver 203 is a GPS receiver where GPS is one example of a GNSS system. A GPS receiver may provide GPS coordinates of the UAV. GPS coordinates may have a relatively high margin of error and so additional sensor systems may be used in conjunction with GPS to increase the accuracy of localization of the UAV.

LIDAR 204 may comprise an emitter that generates pulsed laser light and a detector for receiving the reflected pulses. Differences in laser return times and wave lengths may be used to generate a 3D point cloud comprising location information in 3D space and laser reflection intensities. The 3D point cloud may be processed to build a map of the 3D environment, including both topography and objects.

Communication system 205 may comprise one or more wireless interfaces or wirelines interfaces to enable the UAV to communicate via one or more networks. Wireless interfaces may enable communication over one or more wireless communication protocols, such as Bluetooth, Wi-Fi, Long-Term Evolution (LTE), WiMAX, radio-frequency ID (RFID), near-field communication (NFC), and other wireless communication protocols. Wireline interfaces may include interfaces to wired networks such as Ethernet, universal serial bus (USB), or other wired networks such as coaxial cable, optical link, fiber-optic link, and so on. Communication system 205 may enable the receiving of remote-control commands from a human operator. Communication system 205 may also enable the sending of sensor data from the UAV to remotely located computer systems for processing, storage, or display.

Power system 206 may comprise components for providing power to the UAV. In an embodiment, the power system 206 may comprise one or more batteries. In other embodiments, the power system 206 may comprise solid or liquid fuel.

Processor 207 may comprise a computer processor for executing one or more program instructions 212 on the data storage 208. The processor may be a general-purpose processor or a special purpose processor (e.g., digital signal processors, application specific integrated circuits, and so on). The processor may be configured to execute program constructions to provide the functionality of a UAV described herein.

Data storage 208 may comprise any form of computer-readable storage that can be read or accessed by processor 207. The data storage may be integrated with or separate from the processor 207. Data storage may be temporary, permanent, or semi-permanent and may comprise, for example, RAM, ROM, optical media, flash memory, hard disk, solid state drives (SSD), mechanical hard drives, or other storage. While illustrated as a single data storage 208, it should be understood that data storage 208 may comprise any number of separate or integrated data storages.

The data storage 208 may store one or more program instructions 212 for implementing the functionality described herein. Navigation system 213 may be stored as program instructions stored in the data storage 208. The navigation system 213 may comprise instructions for moving and maneuvering the UAV by issuing instructions to the propulsion components and control components of the UAV. Service system 214 may comprise program instructions for providing a service function of the UAV. For example, services provided by the UAV may include mapping, traffic monitoring, delivery services, or emergency response. The service system 214 may comprise the instructions for providing the desired service.

In some embodiments, UAV 101 may comprise a payload 220, such as when the service performed by the UAV 101 require delivery or use of one or more payload objects. For example, in a delivery task, the payload 220 may comprise one or more payload objects for the UAV 101 to deliver to a recipient.

UAV 101 may include additional components not illustrated in FIG. 2. For example, UAV 101 may include a plurality of additional sensors such as radar, ultra-sonic sensors, proximity sensors, temperature sensors, light sensors, microphones, and so on. UAV 101 may also include output systems such as speakers, lights, display screens, and so on.

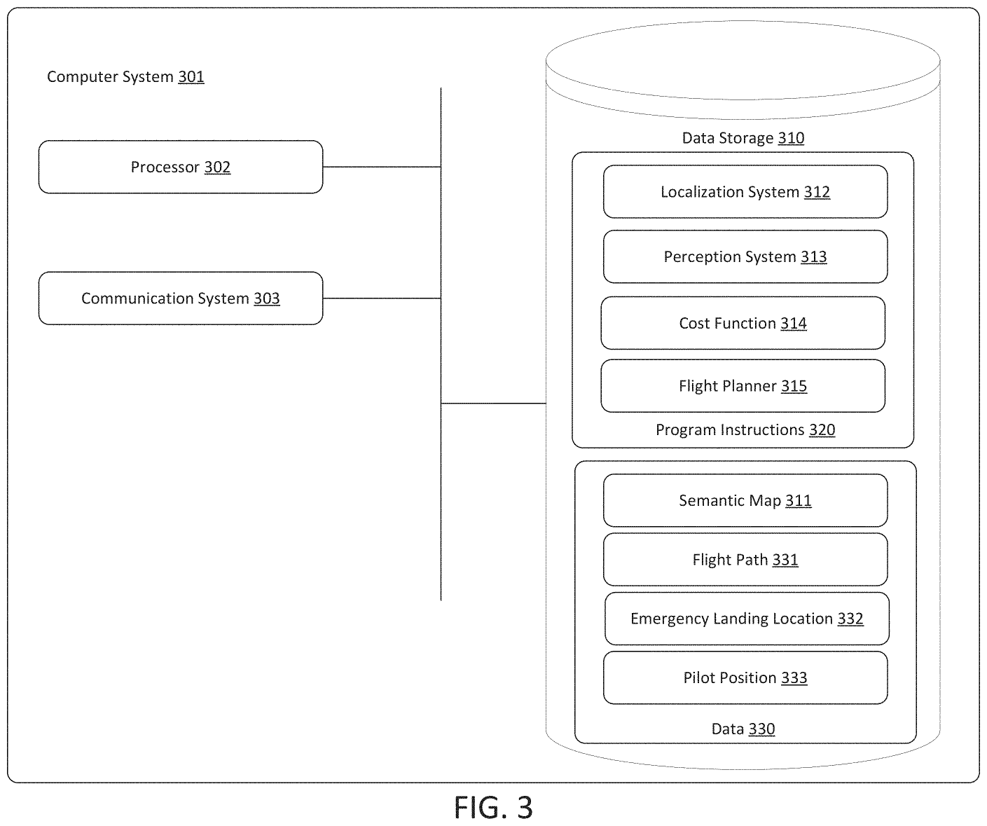

FIG. 3 illustrates an exemplary embodiment of a computer system 301 that may be used in some embodiments to perform functionality described herein. The computer system 301 may implement the flight planner 315 for generating a ground-aware flight path for UAV 101 as described elsewhere herein. The flight planner 315 may develop the ground-aware flight path by making use of semantic map 311, localization system 312, and perception system 313 in addition to a cost function 314.

In some embodiments, the computer system 301 is onboard the UAV 101. For example, in one embodiment, the processor 302 is the processor 207, the communication system 303 is the communication system 205, and the data storage 310 is the data storage 208. In such embodiments, the UAV's onboard computer system performs the functionality of computing a ground-aware flight path using the flight planner 315. The semantic map 311, localization system 312, perception system 313, cost function 314, flight planner 315, and emergency landing location 330 may all be onboard the UAV 101 in its data storage 208.

In other embodiments, the computer system 301 may be offboard the UAV 101 and may compute the ground-aware flight path remotely from the UAV 101 and transmit the resulting flight path, or control instructions to implement the flight path to the UAV 101. For example, the computer system 301 may be a ground station computer system. For example, the computer system 301 may receive communications of sensor data from the UAV 101 via the communication system 303 and compute the flight path for transmission to the UAV 101. In some examples, the flight path is computed remotely from the UAV 101 and displayed to a human operator who remotely controls the UAV 101 to implement the flight path. In such an example, the entire flight path does not need to be transmitted to the UAV 101 and only individual control instructions to implement the flight path are transmitted to the UAV 101. In other embodiments, the UAV 101 may be autonomous and an offboard computer system may compute a flight path and automatically transmit control instructions to the UAV 101 to be implemented by the navigation system 213.

The processor 302 may comprise a computer processor for executing one or more program instructions 320 on the data storage 310. The processor may be a general-purpose processor or a special purpose processor (e.g., digital signal processors, application specific integrated circuits, and so on). The processor may be configured to execute program constructions to provide the functionality of ground-aware flight planning as described herein.

Communication system 303 may comprise one or more wireless interfaces or wirelines interfaces to enable the computer system 301 to communicate via one or more networks. Wireless interfaces may enable communication over one or more wireless communication protocols, such as Bluetooth, Wi-Fi, Long-Term Evolution (LTE), WiMAX, radio-frequency ID (RFID), near-field communication (NFC), and other wireless communication protocols. Wireline interfaces may include interfaces to wired networks such as Ethernet, universal serial bus (USB), or other wired networks such as coaxial cable, optical link, fiber-optic link, and so on. When the computer system 301 is offboard of the UAV 101, the communication system 303 may enable the receiving of sensor data from the UAV 101. Moreover, communication system 303 may also enable the sending of remote control instructions, or an entire or partial flight path, to the UAV 101.

The data storage 310 may store one or more program instructions 320 and data 330 for implementing the functionality described herein.

Semantic map 311 may comprise a detailed map of an environment in which the UAV 101 operates or may operate. The semantic map may include 2D and/or 3D data, including information about topography and structures. The semantic map may comprise semantic information about ground events (comprising ground objects and conditions) that are temporary, permanent, or semi-permanent. Each ground event may comprise a name, description, type, and coordinates (X, Y, Z) of the event's location. The name of the ground event may identify it and the type may categorize the ground event into a general type. The description of the ground event may provide further information about the ground event.

Localization system 312 may comprise computer instructions for localizing UAV 101. Localization may be performed based on the IMU, GNSS, image-based localization, LIDAR-based localization, other methods, and any combination of the foregoing.

Perception system 313 may comprise computer instructions for performing perception in the UAV 101 based on the sensor inputs from sensors including imaging system 202, LIDAR 204, or other sensors. Perception system may comprise an object detection system for detecting objects in the environment.

In one embodiment, perception system may use computer vision algorithms for recognizing objects and ground features. For example, in one embodiment an image or video may be input to a multi-layer neural network to generate output identifying the location and identity of one or more objects. The multi-layer neural network may include neural network layers of different types such as convolutional neural network layers and fully-connected neural network layers. The neural network may be trained on training examples comprising an image and one or more training labels that identify the objects in the image and their location. In some embodiments, semantic segmentation may be performed to identify not just the location of objects but to semantically segment the image to assign individual pixels to objects. As a result of semantic segmentation, regions of pixels may be identified corresponding to each object in the image.

In some embodiments, object detection may be performed by using feature extraction to identify specific features of an image prior to using a machine learning model. Feature extraction may comprise applying an interest point detector to identify points of interest in an image. In some embodiments, an affine invariant interest point detector, such as Scale-Invariant Feature Transform (SIFT), may be applied. An affine invariant interest point detector is relatively invariant to affine deformations to an image. After the interest point detector is applied, a descriptor generator may be run on the interest points to generate an image descriptor (or feature vector) for each interest point. Descriptor generators may be partially or fully invariant to intensity and contrast changes and geometric deformations. For example, a SIFT descriptor may be used in some embodiments. Once image descriptors have been computed at each interest point, the resulting image descriptors may be input to a machine learning model to perform detection of objects. Nonetheless, feature extraction is optional and many deep learning machine learning models do not include this step and accept the image itself, or a pre-processed version of the image, as an input for object detection. The aforementioned object detection methods may also be used to detect ground features for use in localizing the UAV by localization system 312. Recognizable ground objects may be detected like buildings, trees, signs, and topographical features to help localize the UAV by comparing the ground objects detected by the perception system with known ground features in the semantic map 311.

Cost function 314 may accept as input an identity of a ground event, such as a ground object or ground condition, and output a weight of a path for flying over or in the vicinity of the ground event. In some embodiments, the cost function may output different weights for flying over the ground event and flying in the vicinity of the ground event. Weights may be numerical values such as integers, real numbers, floating point numbers, Boolean values, and so on. For example, the weight for a path that flies directly over a person may be very high because it can be dangerous to do so in the event that the UAV falls to the ground, while the weight for a path that flies near a person may be somewhat lower because it is not as dangerous as flying over the person.

In some embodiments, the cost function 314 may identify certain paths as completely impassable. For example, in some embodiments, it may be entirely prohibited to fly over a person. In such an embodiment, the cost function 314 may output the location of impassable obstacles. Although illustrated as a single cost function 315, it should be understood that a plurality of cost functions may be used.

Flight planner 315 may comprise a computer program for generating a flight path. The flight planner 315 may accept as input the weights of different paths or regions output by the cost function 314. The flight planner 315 may apply those weights to a pathfinding algorithm to determine a lowest cost path. If the cost function 314 has identified impassable obstacles, those obstacles may also be input to and applied by the flight planner 315, with the flight planner only generating paths that do not pass through the obstacles. The flight planner 315 may use pathfinding algorithms such as rapidly exploring random tree algorithm (RRT), A* algorithm, Dijkstra's algorithm, D* algorithm, any-angle path finding, hierarchical path finding, and other algorithms. The lowest cost path may be output by the flight planner 315 as the selected path.

Data 330 may comprise data for storage. Data 330 may comprise the flight path 331, which may be represented as a plurality of waypoints. The waypoints may be represented as X, Y, Z coordinates, an orientation, and an optional velocity and acceleration. In an embodiment, the computer system 301 stores and maintains an emergency landing location 332 for the UAV 101. The emergency landing location 332 may comprise an identifier and coordinates of a location where the UAV 101 may make an emergency landing. In some embodiments, the UAV 101 maintains an emergency landing location 332 at all times. In some embodiments, a plurality of emergency landing locations 332 may be maintained and ranked with a primary emergency landing location, secondary emergency landing location, tertiary emergency landing location, and so on. The emergency landing location may also be computed and output by the flight planner 315 during the flight of the UAV 101 and may be used to update the stored emergency landing location 332. When a plurality of emergency landing locations are stored, the ranking of precedence of the emergency landing locations may be changed based on the flight planner 315 outputting a ranked list of the best emergency landing locations based on the UAV's current position. Data 330 may also comprise a pilot position 333 indicating the location of the pilot of the drone, such as in (X, Y, Z) coordinates. The pilot position 333 may allow detection of when the drone may move to a location that is out of the line of sight of the pilot, which may be undesirable or prohibited by law. Therefore, analysis of the pilot position 333 may affect the flight path 331 that is chosen.

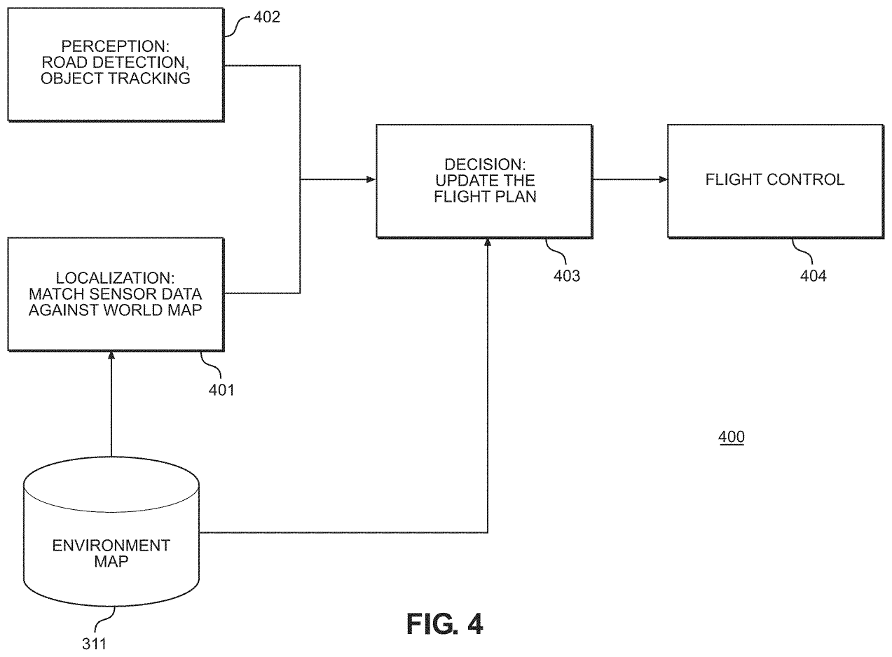

FIG. 4 illustrates an exemplary method 400 for updating a flight path based on ground-awareness in one embodiment. In exemplary method 400, the semantic map 311, localization system 312, and perception system 313 are used to update a flight path based on ground-awareness. In method 400, the semantic map 311 is provided to the computer system 301 and stores semantic information about ground events, including ground objects and ground conditions.

Localization 401 is performed by the localization system 312 by applying the sensor data collected from the UAV from one or more sensors, such as the IMU 201, imaging system 202, GNSS 203, and LIDAR 204. Localization may be performed by a combination of these sensor systems to localize the UAV more accurately than could be performed with one sensor system alone. Any of the methods of localization described herein related to localization system 312 may be performed in the localization step 401. The localization step 401 generates a coordinate location of the drone in 3D space comprising X, Y, and Z coordinates and an orientation comprising rotation information in 3D space.

Perception 402 is performed by the perception system 313 by applying the sensor data of the UAV, such as the imaging system 202, LIDAR 204, depth sensors, ultrasonic sensors, and other sensors. Perception 402 detects the real-time environment in the vicinity of the UAV. Perception 402 may detect roads, ground objects, ground conditions, topography, and other objects and events.

As a result of localization 401 and perception 402, ground events (both ground objects and ground conditions) are identified. In the localization step 401, the localization of the UAV identifies its coordinates and places it within the semantic map 311. Ground events in the semantic map 311 that are near the coordinates of the UAV are identified. Real-time ground events are also identified by the perception step 402.

Decision step 403 comprises updating the flight path of the UAV based on the ground events observed based on localization 401 and perception 402. The flight path of the UAV may be updated to avoid certain ground events or to move toward or follow other ground events.

Optionally, the emergency landing location 332 may be updated based on the ground events observed based on localization 401 and perception 402. The emergency landing location may be selected based on identifying a suitable landing location based on ground features (e.g., an open field) and the existence of a low cost path to travel to the suitable landing location. In an embodiment, the computer system 301 identifies a plurality of candidate emergency landing locations based on ground features in the vicinity of the UAV identified through localization 401 and the semantic map 311 and evaluates the path weights to travel to each candidate emergency landing location. The computer system 301 then selects and stores the candidate emergency landing location with the lowest cost path to reach it.

The resulting updated flight path is then used for flight control 404 of the UAV in flight. In some embodiments, the updated flight path is transmitted to the UAV. In other embodiments, the updated flight path is used to generate new navigation commands that are transmitted to the UAV.

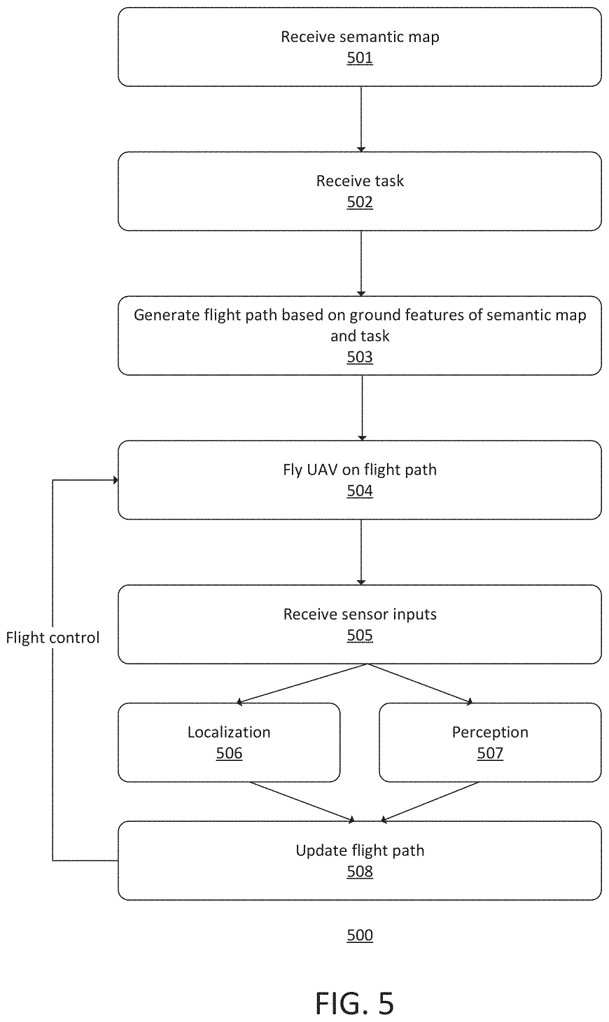

FIG. 5 illustrates an exemplary method 500 that may be performed in some embodiments to generate an initial flight path and update the flight path during flight.

In step 501, a semantic map 311 is received, such as from storage on computer system 301.

In step 502, a task is received, where the task defines the objective of the UAV. In some embodiments, task may be mapping and surveying, monitoring traffic, goods delivery, emergency response, and other tasks.

In step 503, a flight path is generated based on the ground features of the semantic map and the task. Generating the flight path may comprise generating one or more waypoints of the flight path. Ground features comprise any of the ground events, such as ground objects and ground conditions, in the semantic map and topography. The task defines the objective of the UAV and therefore also helps determine the necessary flight path. For example, when the task is mapping and surveying, the flight path may be generated to follow ground features such as roads, pathways, terrain, hills, water features like rivers, streams, or lakes, or other ground features. When the task is monitoring traffic, the flight path may navigate the UAV to a roadway or intersection and cause the UAV to pause to monitor traffic at one or more specific waypoints before resuming flight to other waypoints. When the task is goods delivery, the flight path may navigate the drone from a package pickup location to a package delivery location and then on a return trip back to a home base. When the task is emergency response, the flight path may navigate the drone from a home base to the location of an individual needing emergency assistance, where the drone may provide medical supplies or monitor the situation.

In step 504, the UAV flies along the flight path. In some embodiments, the UAV flies autonomously, partially autonomously, or under remote-control. In one embodiment, one or more waypoints generated in a flight path are displayed to a human operator who flies the UAV between the waypoints. The operation of the UAV between the waypoints may optionally be autonomous or partially autonomous. In one embodiment, the human operator selects an option to fly the UAV to the next waypoint in a plurality of waypoints, and the UAV flies to the next waypoint autonomously.

In step 505, sensor inputs are received by the UAV during flight. The sensor inputs are transmitted to the computer system 301, which may be onboard or offboard. In step 506, localization is performed by the localization system 312. In step 507, the perception system 313 perceives the external environment based on the sensor data. In step 508, the flight path is updated based on the ground events identified by the localization 506 and perception 507 steps. Updating the flight path may comprise generating or updating one or more waypoints of the flight path. Optionally, a new emergency landing location may also be generated in step 508

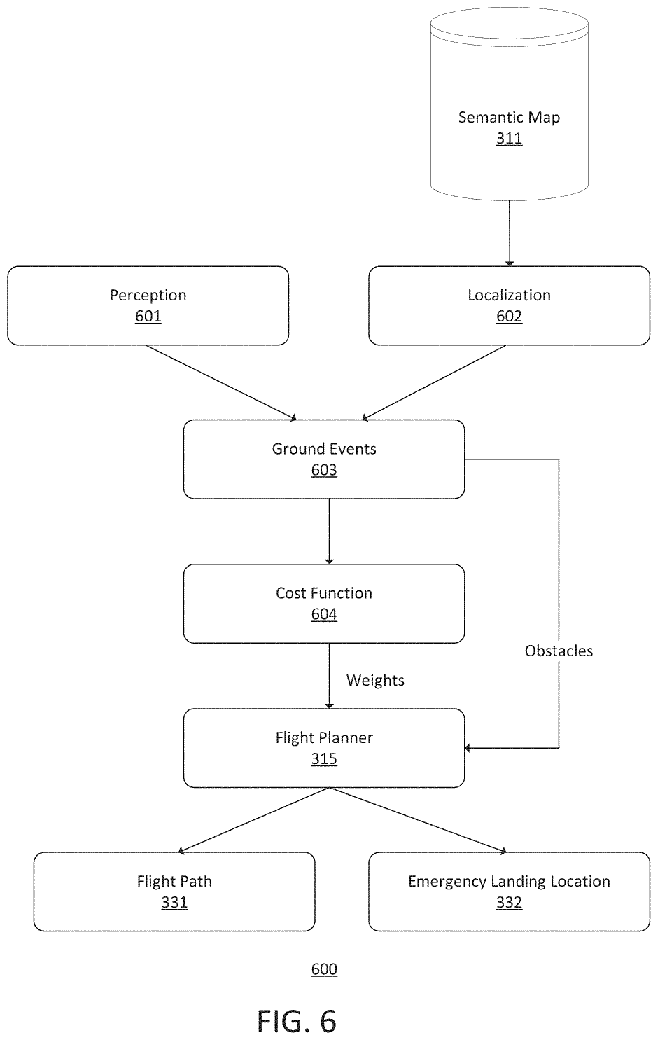

FIG. 6 illustrates an exemplary method 600 for using a cost function and flight planner to generate a flight path. Semantic map 311 is provided and used as input for localization 602. Localization also uses sensor data and places the UAV at a precise location within the semantic map 311. Perception 601 is also performed to observe the external environment around the UAV and detect ground events. As a result of perception 601 and localization 602, ground events 603 are detected. A name, description, type, and coordinates of the ground events 603 may be generated based on the perception 601 or localization 602.

Some ground events 603 may be determined to be impassable obstacles. For example, the ground event 603 may be physically impassable, such as a tall tree or power line. In other examples, the ground event 603 is not physically impassable but is impassable due to legal regulations or an unacceptable risk that would occur due to passing over the ground event. In some embodiments, a person or a moving vehicle may be determined to impassable because it would be unacceptable for the UAV to fly over them. The impassable obstacles may be passed directly to the flight planner 315 to be handled as impassable obstacles.

For one or more ground events 603 that are not impassable obstacles, the ground events 603 are passed to cost function 604. The cost function 604 may accept as input one or more ground events and output a weight for each ground event. The weight may represent the cost of the UAV flying over the ground event or in the vicinity of the ground event. A high weight may disincentivize a flight path and a low weight may incentivize the flight path. In some embodiments, separate weights may be returned for flying over the ground event and flying near the ground event. In some embodiments, different weights may be returned for flight paths based on how near the UAV flies to the ground event. For example, a flight path that travels closer to the ground event may have a higher weight than a flight path that is farther away from the ground event. The cost function weights may be associated with certain regions or coordinates in a map or to specific paths. When the weights are associated with regions or coordinates, then the weights may also be assigned to paths that travel over or through the regions or coordinates.

The cost function may be implemented in a variety of ways such as a hash table or lookup table mapping types of ground events to weights, a linear combination that weights one or more aspects of the ground event and sums the weighted values, a non-linear function that computes the weight based on one or more aspects of the ground event, and so on. Any of the aspects of the ground event, such as the name, description, type, and coordinates may be used by the cost function to compute the weight. In some embodiments, the same weight is returned for all ground events of the same type. In other embodiments, different weights may be returned even for ground events of the same type. Moreover, in some embodiments, a plurality of cost functions are used rather than a single cost function.

The weights generated by the cost function are input to the flight planner 315. The flight planner applies the weights to a pathfinding algorithm to determine a lowest cost path. The flight planner may apply the weights to existing paths between waypoints. The flight planner may generate new candidate paths with new waypoints and compare the weights of existing paths to weights of the new candidate paths. When a candidate path with a lower weight is found for traversing the distance between two waypoints, then the candidate path may be used to replace an existing higher-weight path. When no path has yet been generated, the flight planner may generate a plurality of candidate paths between waypoints and select the candidate path with lowest cost. The flight planner may also apply the impassable obstacles found to the pathfinding algorithm so that no paths that cross through an obstacle are returned. The flight planner 315 may use pathfinding algorithms such as rapidly exploring random tree algorithm (RRT), A* algorithm, Dijkstra's algorithm, D* algorithm, any-angle path finding, hierarchical path finding, and other algorithms. The lowest cost path may be output by the flight planner 315 as the selected path.

Optionally, the flight planner 315 may also generate an emergency landing location that is the emergency landing location 332 that is in the vicinity of the UAV and has the lowest cost path to reach it. The paths to emergency landing locations may be evaluated by the flight planner 315 in the same way as the flight path. The paths may be assigned weights based on the ground events that the pass over or near. Moreover, paths that travel through obstacles may be eliminated from consideration. The lowest cost viable path to an emergency landing location may be selected along with its associated emergency landing location.

In some embodiments, the flight planner 315 maintains a buffer zone between the UAV's flight path 331 and roads. The flight planner 315 may generate flight paths 331 where a buffer zone is maintained between the flight path 331 and the road. In an embodiment, the cost function may output weights to keep the UAV from traveling too close to a road. It may be desired for a UAV to keep a certain distance from a road, such as 2 feet or 5 feet in terms of distance in the X-Y plane (not considering altitude). In an embodiment, a road buffer distance may be stored as a threshold value and may define the desired buffer distance for a UAV to keep from a road. The cost function may assign a high weight to paths that cross within the road buffer distance of a road. In other embodiments, the area within the buffer distance may be passed as an obstacle by the localization system 312 or perception system 313 to the flight planner 315 so that the UAV cannot cross into the buffer zone.

In some embodiments, the flight planner 315 generates a flight path 331 to allow the UAV to survey or map a road. In this embodiment, the flight planner may generate a flight path that causes the UAV to fly close to roads but outside a road buffer zone. In an embodiment, the cost function may output weights to cause the UAV to fly close to roads without flying within the road buffer zone. For example, flying close to roads and following roads may be desirable for applications of surveying or mapping roads. In such an embodiment, the cost function may include low weights for paths that successfully follow a road, but include a high weight when the paths cross into the buffer zone. The cost function may assign a high weight to paths and regions that are within the buffer zone.

In some embodiments, the flight planner 315 generates flight paths that prioritize straight line paths over paths that require turning. In an embodiment, the cost function may output weights to incentivize the UAV to travel in straight lines and disincentivize turning. Many commercial IMUs 201 lose accuracy during turning maneuvers so that, in a turn, the position and orientation information sensed by the UAV may be highly inaccurate. As a result, it would be desirable for the UAV to travel in straight lines when possible and avoid turning. In an embodiment, the cost function may assign a high weight to paths that require the UAV to turn from its present course. Thus, for one or more waypoints, the cost function may check the UAV's orientation at a waypoint and the necessary orientation of the UAV to travel along the next path following the waypoint. Upon detecting that the UAV must turn following the waypoint to travel along the next path, the cost function may assign a high weight to the given next path. In some embodiments, the value of the weight may depend upon the extent of the turning maneuver needed, where a larger turn may be assigned a higher weight than a smaller turn.

In some embodiments, the flight planner 315 prevents the UAV from flying over moving vehicles but allows the UAV to fly over vehicles that are stopped. In an embodiment, the cost function may output weights to disincentivize the UAV from traveling over moving vehicles. The perception system 313 may detect whether vehicles on the ground are moving or are stationary and output the presence of the moving or stationary vehicles to the cost function. The cost function may assign a high weight to paths traveling over, or regions including, moving vehicles to disincentivize paths traveling over moving vehicles. It may assign a lower weight to paths traveling or stationary vehicles to allow the UAV to travel over them. In some embodiments, the presence of moving vehicles may be passed as an obstacle to the flight planner 315 so that the UAV cannot cross over the moving vehicles.

In some embodiments, the flight planner 315 has a higher preference for generating flight paths over less populous rather than more populous regions. In an embodiment, the cost function may output weights based on how populous a region is. The cost function may receive population information from the localization system 312 based on localization of the UAV and population information about various regions from the semantic map 311. The cost function may assign a high value to a region that is more populous and a low value to a region that is unpopulated or has a low population in order to incentivize the UAV to travel in less populous regions. Paths traveling over a populous region may be assigned a high weight and paths traveling over a less populated region may be assigned a lower weight.

In some embodiments, the UAV sensors detects objects, such as tall ground structures (e.g., buildings) or formations such as hills, trees, or foliage that are between the future locations of the UAV on the flight path 331 and the pilot position 333. The future locations of the UAV may be future waypoints of positions between waypoints. Flight planner 315 may determine that the objects would block the line of sight between the pilot and the UAV, if the UAV were to continue on the flight path 331. The flight planner 315 may generate a new flight path 331 to avoid traveling on a path that would cause the UAV to go outside the pilot's line of sight. In an embodiment, the aforementioned feature may be implemented by applying the cost function to output weights to disincentivize the UAV from traveling to a point where it is out of the line of sight of the pilot. Upon detecting ground events 603 by the perception system 313, one or more tall objects may be identified. One or more lines may be traced from the pilot position 333 to determine where the pilot can see and areas behind the tall objects may be considered to be blocked. The areas that are blocked may be assigned high weight by the cost function to disincentivize the UAV from traveling to those locations.

In some embodiments, the UAV detects the location of roads from the semantic map 311 and/or the perception system 313. Upon detecting a road, the perception system 313 detects and measures the flow of vehicles and pedestrians on the road. When it is determined that there are no vehicles and pedestrians or that the vehicles are stopped, then the UAV may continue its flight. When it is determined that there are pedestrians or moving vehicles, then the UAV may stop until it detects that the road has cleared.

In some embodiments, UAV detects that it is entering a region where the semantic map 311 is incomplete or lacking data. The lack of data may include lack of LIDAR point cloud data, lack of image data (e.g., image data of the ground from the aerial view of the AUV), and so on. Upon this detection, the UAV may activate its sensors and collect data to fill the gaps in the semantic map 311. The collected data may be downloaded or transmitted from the UAV to a remote server. A map building program may be used to compute complete map information from the collected data and add the new map information to semantic map 311.

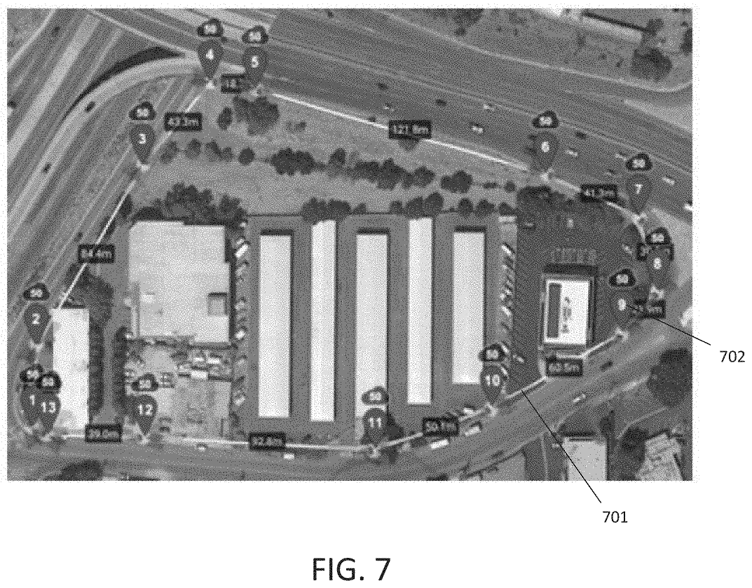

FIG. 7 illustrates an exemplary flight path 701 comprising a plurality of waypoints 702. The waypoints are numbered 1 to 13 to identify their order in the flight path. The flight path 701 may be suitable for surveying and mapping roads. The flight path 701 maintains a suitable buffer distance from the roads and follows the road to allow successful mapping and surveying of the road.

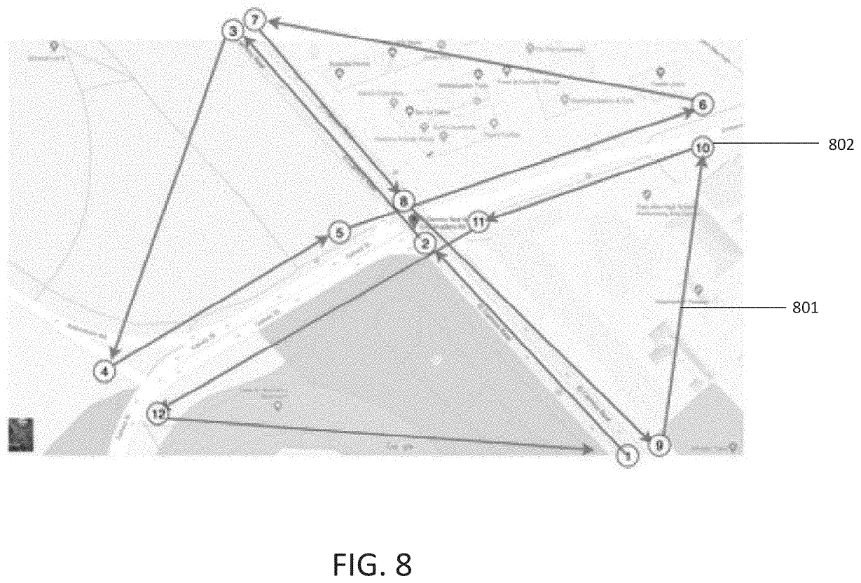

FIG. 8 illustrates an exemplary flight path 801 comprising a plurality of waypoints 802. The waypoints are numbered 1 to 12 to identify their order in the flight path. The flight path 801 optimizes for flying straight lines and minimizing turns. The flight path 801 allows for surveying and mapping roads while keeping turns to a minimum. At each of the intersections, the flight path may provide for the UAV to stop and monitor traffic to ensure that vehicles have stopped before it travels over the intersection.

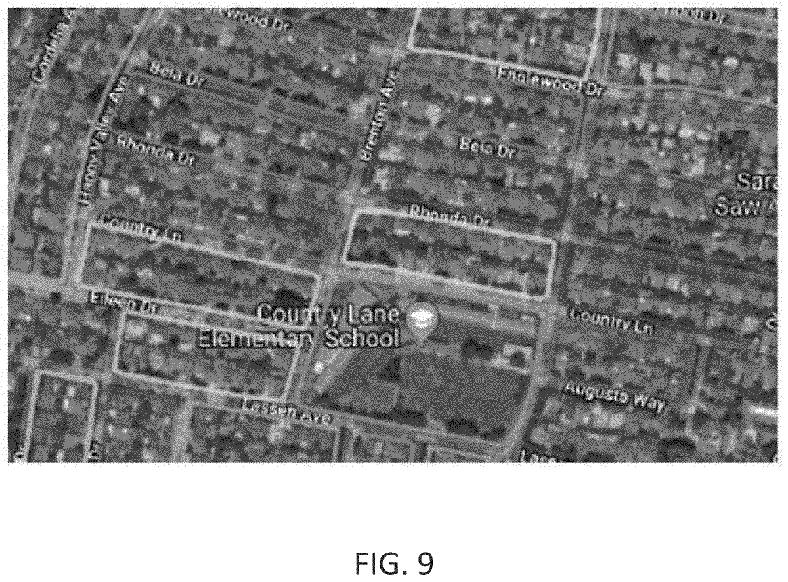

FIG. 9 illustrates an exemplary series of flight paths that may be used for surveying and mapping roads. The lines show the flight path of the UAV as it follows various roads in a neighborhood.

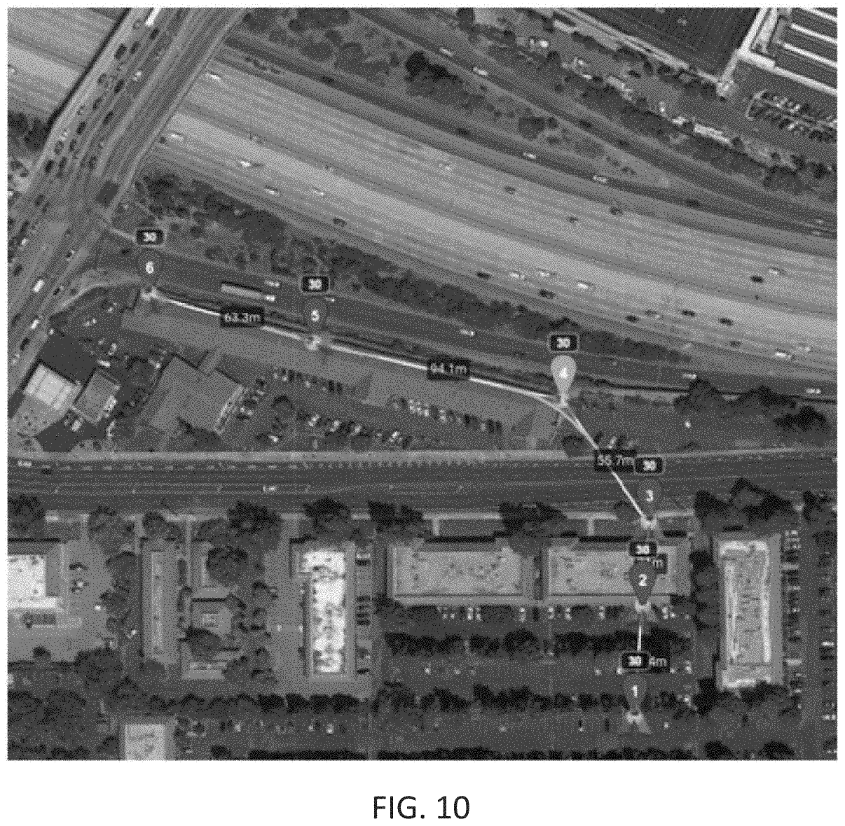

FIG. 10 illustrates an exemplary flight path that may be used for traffic monitoring. The UAV may travel along the flight path and stop at one or more of the waypoints to monitor traffic before continuing on to the next waypoint. The UAV may pause at waypoint 3 to wait until no traffic is on the roadway before proceeding to cross the road to waypoint 4.

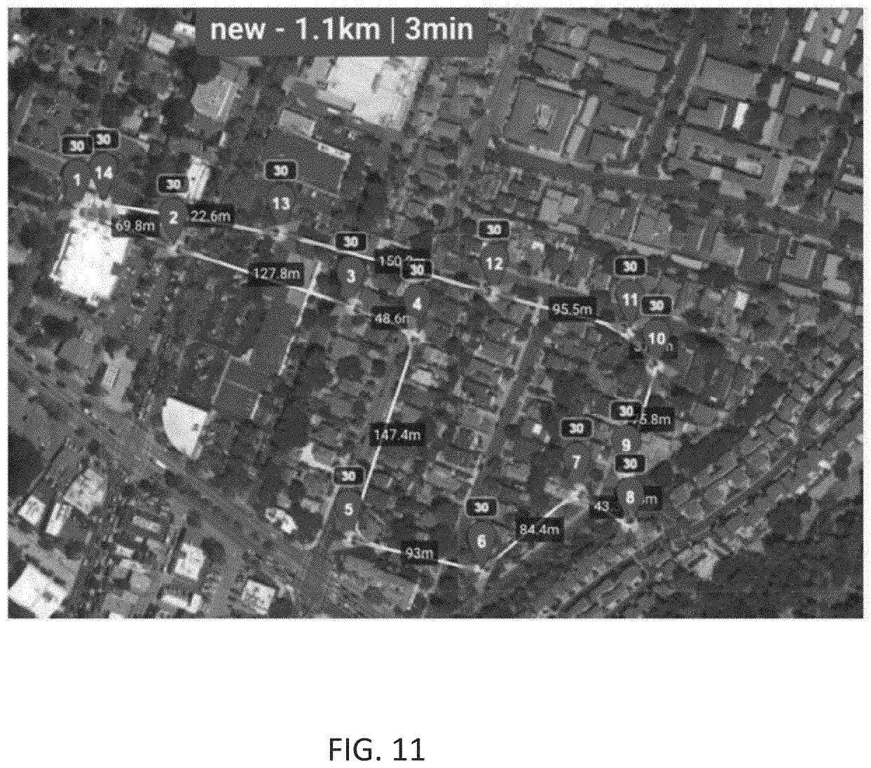

FIG. 11 illustrates an exemplary flight path that may be used for goods delivery by the UAV. In a goods delivery task, the flight path may be optimized for traveling in a shortest path comprising as many straight lines as possible. The flight path may also be optimized for traveling over less populous regions and waiting for traffic to clear before crossing any roads.

A number of implementations have been described. Nevertheless, it will be understood that various modifications can be made without departing from the spirit and scope of the invention. In addition, the logic flows depicted in the figures do not require the particular order shown, or sequential order, to achieve desirable results. In addition, other steps can be provided, or steps may be eliminated, from the described flows, and other components can be added to, or removed from, the described systems. Accordingly, other implementations are within the scope of the following claims.

What is claimed is:

1. A computer-implemented method for operating an unmanned aerial vehicle (UAV) comprising:
receiving a semantic map for a geographic area over which the UAV is deployable, the semantic map comprising data about a first set of ground events;
providing instructions to a control system to navigate a UAV on a flight path;
receiving, by the UAV, input sensor data from sensors on the UAV, the sensors directed toward the ground;
localizing, by a localization system, the UAV based on GPS and the input sensor data;
perceiving, by a perception system, real-time data about the ground in the vicinity of the UAV based on the input sensor data and detecting a second set of ground events;
updating the flight path, by a flight planner, based on the first and second sets of ground events;
providing instructions to the control system to navigate the UAV on the updated flight path.

2. The computer-implemented method of claim 1, further comprising localizing the UAV based on imaging data from an imaging system.

3. The computer-implemented method of claim 1, further comprising optimizing the flight path, by the flight planner, to minimize the number of turns in the updated flight path.

4. The computer-implemented method of claim 1, further comprising optimizing the flight path, by the flight planner, to maintain a threshold distance between the UAV and a plurality of roads.

5. The computer-implemented method of claim 1, further comprising optimizing the flight path, by the flight planner, to cause the UAV to wait at a road intersection until a plurality of vehicles are stopped before passing over the road intersection.

6. The computer-implemented method of claim 1, further comprising selecting an emergency landing location, by the flight planner, based on the first and second set of ground events.

7. The computer-implemented method of claim 1, further comprising:
storing a pilot position;
detecting a ground obstacle and determining that the ground obstacle blocks line of sight from the pilot position to a position on the flight path;
updating the flight path so that the flight path is in line of sight from the pilot position.

8. The computer-implemented method of claim 1, further comprising:
detecting a gap in the semantic map;
collecting data from one or more sensors to fill the gap;
updating the semantic map based on the collected data.

9. The computer-implemented method of claim 1, further comprising measuring the flow of vehicles on a road and optimizing the flight path, by the flight planner, to cause the UAV to wait until the flow of vehicles has stopped before passing over the road.

10. A computerized flight planner and operations system for an unmanned aerial vehicle (UAV) comprising:
a processor;
a non-transitory computer-readable medium comprising:
a semantic map for a geographic area over which the UAV is deployable, the semantic map comprising data about a first set of ground events;
instructions for a control system to navigate a UAV on a flight path;
instructions for receiving input sensor data from sensors on the UAV, the sensors directed toward the ground;
a localization system for localizing the UAV based on GPS and the input sensor data;
a perception system for perceiving real-time data about the ground in the vicinity of the UAV based on the input sensor data and detecting a second set of ground events;
a flight planner for updating the flight path based on the first and second sets of ground events;
instructions for the control system to navigate the UAV on the updated flight path.

11. The computerized flight planner and operations system for a UAV of claim 10, wherein the localization system is configured to localize the UAV based on imaging data from an imaging system.

12. The computerized flight planner and operations system for a UAV of claim 10, wherein the flight planner is configured to minimize the number of turns in the updated flight path.

13. The computerized flight planner and operations system for a UAV of claim 10, wherein the flight planner is configured to maintain a threshold distance between the UAV and a plurality of roads.

14. The computerized flight planner and operations system for a UAV of claim 10, wherein the flight planner is configured to cause the UAV to wait at a road intersection until a plurality of vehicles are stopped before passing over the road intersection.

15. The computerized flight planner and operations system for a UAV of claim 10, wherein the flight planner is configured to select an emergency landing location based on the first and second sets of ground events.

16. The computerized flight planner and operations system for a UAV of claim 10, wherein the flight planner is further configured to:
store a pilot position;
detect a ground obstacle and determine that the ground obstacle blocks line of sight from the pilot position to a position on the flight path;
update the flight path so that the flight path is in line of sight from the pilot position.

17. The computerized flight planner and operations system for a UAV of claim 10, wherein the flight planner is further configured to:
detect a gap in the semantic map;
collect data from one or more sensors to fill the gap;
update the semantic map based on the collected data.

18. The computerized flight planner and operations system for a UAV of claim 10, wherein the flight planner is further configured to measure the flow of vehicles on a road and optimize the flight path to cause the UAV to wait until the flow of vehicles has stopped before passing over the road.

19. A computer-implemented method for operating an unmanned aerial vehicle (UAV) comprising:
receiving a semantic map for a geographic area over which the UAV is deployable, the semantic map comprising data about a first set of ground events;
providing instructions to a control system to navigate a UAV on a flight path;
receiving, by the UAV, input sensor data from sensors on the UAV, the sensors directed toward the ground;
localizing, by a localization system, the UAV based on GPS and the input sensor data;
perceiving, by a perception system, real-time data about the ground in the vicinity of the UAV based on the input sensor data and detecting a second set of ground events;
computing, by a cost function, a plurality of weights associated with the first and second sets of ground events based on identifiers of the ground events;
updating the flight path, by a flight planner, based on the plurality of weights;
providing instructions to the control system to navigate the UAV on the updated flight path.

20. The computer-implemented method of claim 19, further comprising:
computing, by the cost function, a plurality of weights associated with a set of candidate flight paths;
applying, by the flight planner, the weights associated with the set of candidate flight paths to minimize the number of turns in the updated flight path.
